(19) United States
(12) Patent Application Publication
(10) Pub. No.: US 2024/0392985 A1
(43) Pub. Date: Nov. 28, 2024

(54) SOLAR-POWERED VENTILATION SYSTEM

(71) Applicant: Roof Turbo, LLC, Manchester, MI (US)

(72) Inventor: Kurt Greaves, Manchester, MI (US)

(21) Appl. No.: 18/782,659

(22) Filed: Jul. 24, 2024

Related U.S. Application Data
(63) Continuation-in-part of application No. 18/141,699, filed on May 1, 2023.

(51) Int. Cl. F24F 7/02; H02S 40/34

(52) U.S. Cl. CPC F24F 7/025; H02S 40/34

(57) ABSTRACT

A ventilation system having a solar panel, a fan assembly and a duct. The solar panel is configured to mount outside an enclosed space and includes a power cord routed to the fan assembly. The fan assembly is situated inside the enclosed space and includes a BLDC motor with commutative motor control. The ventilation system includes a duct with one end configured to be mounted where air is to be drawn into the enclosed space, and a second end mounted to the fan assembly. The solar panel may provide at least about 30 W, 35 W or 40 W under anticipated operating conditions. The solar panel, BLDC motor and motor control are operable to provide airflow of at least about 400 CFM, 380 CFM, 350 CFM or 300 CFM. To enhance performance, the fan assembly may include a rotating blade, an upstream constricting ring and a downstream fixed blade assembly.

### BACKGROUND OF THE INVENTION

The present invention relates to ventilation systems, and more particularly to supplemental ventilation systems that can be added to generally enclosed spaces to introduce ventilation without the need for mains power.

Many buildings include ventilation systems to reduce the negative effect of heat and humidity, particularly in attic spaces located above work and living areas in the buildings. Solar energy impinging the roof of a building heats air in an attic during the day. At night, however, the roof typically cools, and thus cools and condenses air in the attic located below the roof. As a result, the air in the attic can become more humid. In turn, the moisture in the air can settle out on insulation and wood structures in the attic. Over time, the repeated deposition of moisture on the insulation and wood structures in the attic can cause them to deteriorate and/or decay. The moist environment can also attract insects and can result in mold growing in the attic on structures.

The solar energy impinging on the roof also can excessively heat up the air in the attic space. Throughout the day, excess heat in the attic can transfer to the adjacent work and living areas under the attic. As the air temperature in the attic rises due to solar energy, the temperature in the work and living areas usually rises, and sometimes substantially. This can require additional room ventilation or air conditioning in those areas to provide suitable living, work or storage temperatures. In turn, this can consume excess energy to cool the living, work or other areas under the attic.

Some construction entities have attempted to address excess heat and humidity in attic spaces. A common approach is to install passive soffit mounted vents that allow ambient air to passively enter and exit the attic space. While these passive ventilation soffits work on windy days, they do not work so well when the air around the building is stagnant, hot and/or humid.

One attempt to provide ventilation is to install an attic fan, which is configured to force air out of the attic space. Attic fans are typically installed in an opening through the roof covering the attic space. In operation, the attic fan creates negative pressure within the attic space that draws air from the environment into the attic space through essentially all openings that might allow airflow in response to pressure differential. This can lead to the introduction of some of the cooler air situated below the soffit vents, but it can also introduce hotter air situated above or adjacent to ridge vents, roof vents, gable vents and other external locations, thereby limiting the effect of the ventilation. Further, the vents that allow the introduction of fresh air may be located in the roof or toward the top of the attic space, thereby providing a relatively short flow path between the attic fan and the fresh air source. This can leave stagnant air throughout the attic, thereby limiting the overall efficiency of the ventilation system.

Some attempts have been made to provide attic ventilations that help to ensure the introduction of cooler air situated under the soffits. For example, one such system utilizes a soffit mounted fan, such as that shown in U.S. Patent Application 2011/0217194 to Randall. This fan, which is mounted directly to the soffit, however, can be prone to failure due to its exposure to the elements on the soffit. The fan can draw in moisture, dust and debris that directly encounters the fan, and can cause it to malfunction or prematurely wear out. Further, the position of the fan in or under the soffit can cause excess vibration in the soffit, and can yield an annoying tinny hum when the fan is in operation. Further, the mounting of the solar cell on the gutter is unsightly and can be prone to damage when cleaning the gutters.

Although conventional attic ventilation systems provide decent ventilation in some cases, there is room for improvement in operation and efficiency in the field of active ventilation systems.

### SUMMARY OF THE INVENTION

A solar-powered ventilation system capable of installation in a wide variety of enclosed spaces is provided. The ventilation system generally includes a fan assembly, a solar panel and an air duct. The fan assembly is configured to be situated in the enclosed space where it is protected from external environmental conditions. The fan assembly includes an electric motor that is powered by the solar panel. The solar panel is configured to be mounted in a location where it is exposed to the sun, typically, outside the enclosed space. The solar panel is selected to generate sufficient electrical power to operate the electric motor at a speed that provides sufficient air flow rates under anticipated operating conditions. The duct includes a proximal end configured to be mounted in communication with the environment outside the enclosed space and a distal end mounted to the fan assembly. In use, the fan assembly is powered by the solar panel and is operated to pull air from the environment through the duct into the enclosed space, thereby providing positive pressure inside the enclosed space, which in turn causes air to vent from the enclosed space through available ventilation paths, such as through a roof vent, ridge vent, gable vent, soffit vent, window or other opening between the enclosed space and the surrounding environment. The ventilation system may be configured to provide air flow of at least approximately 400 CFM, 375 CFM, 350 CFM, 325 CFM or 300 CFM when receiving adequate power from the solar panel.

In one embodiment, operation of the ventilation system is controlled by an electronic control system or motor control. The motor control is powered by the solar panel and implements control algorithms that provide appropriate operation of the electric motor. The motor control is configured to engage the motor only when sufficient power is provided by the solar panel. In one embodiment, the motor control does not operate the motor unless the power received from the solar panel is sufficient to provides at least about 6 VDC to the motor. In one embodiment, the motor is a soft start motor with a starting voltage of 6V and an operating voltage range of about 8 VDC to about 28 VDC.

In one embodiment, the fan assembly includes an electronically commutated brushless DC motor (“BLDC”). The BLDC motor may be a three-phase DC motor with a plurality of permanent magnets in the rotor and a plurality of stationary windings in the stator. Although the winding configuration may vary from application to application, the windings may be arranged to provide the BLDC motor with nine poles (three poles for each phase). In alternative embodiments, the motor may be a one- or two-phase BLDC motor.

In one embodiment, the control system includes a motor control that energizes (or commutates) the windings in stator in a controlled sequence to produce a rotating magnetic field that interacts with the permanent magnets in the rotor to drive rotation of the rotor.

In one embodiment, the control system implements BLDC motor control that includes an arrangement of gate drivers and power transistors that control the supply of power to the motor. In one embodiment, the power transistors include three pairs of switches (each pair including a high-side switch and a low-side switch) arranged in a three-phase inverter with six power transistors arranged in a bride configuration, with each pair governing the switching for one phase of the motor. The power transistors may be MOSFETs.

In one embodiment, the motor control includes gate drivers that amplify the control signals coming from the microcontroller to drive the power transistors. In operation, the motor may be controlled using pulse-width modulation (“PWM”), for example, to control the voltage and current supplied to the motor windings. In one implementation, PMW signals are generated under precise control to actuate a plurality of high-side gate drivers, with each high-side gate driver arranged to actuate a separate one of the high-side power transistors and therefore control the high side of a separate phase of the motor.

In one embodiment, the motor control implements a sensorless commutation control scheme in which internal feedback, such as current, voltage or electromotive force (“back-EMF”) is used to determine the precise sequence for switching the current in the stator windings across the three phases to generate a rotating magnetic field. In alternative embodiments, the motor control may implement a sensor-based commutation scheme in which the control signals are based largely on sensor feedback, such as hall effect sensors that operatively interact with permanent magnets in the rotor.

In one embodiment, the solar panel is mountable to an external structure proximate to the enclosed space, such as a roof or wall, in a position where the solar panel is exposed to sunlight (typically, direct sunlight). In one embodiment, the ventilation system includes a power cord configured to electrically couple the solar panel to the fan assembly. A solar panel having a maximum rated power output of 30 Watts, 35 Watts or 40 Watts may be used in alternative embodiments, but solar panels of differing power and voltage outputs may be used in alternative embodiments.

In one embodiment, the fan assembly includes the electric motor that is affixed to a rotating blade assembly such that operation of the blower motor results in rotational movement of the rotating blade assembly, which in turn cause the flow of air. In one embodiment, the fan assembly may include a stationary blade assembly disposed downstream from the rotating blade assembly. The stationary blade assembly is configured to direct and straighten the airflow that exits the rotating blade assembly. For example, the fixed blades may be configured to convert rotational energy into linear airflow, thereby reducing turbulence and increasing efficiency which result in more consistent and directed airflow.

In one embodiment, the fan assembly includes a constricting ring disposed upstream from the rotating blade. The constricting ring may be generally ring-shaped and have a somewhat triangular cross section that gradually constricts and then gradually opens the airflow path. The constricting ring may provide a range of benefits. For example, the constricting ring is selected to convert static pressure into dynamic pressure as the air accelerates through the narrow section, which improves energy transfer from the blades to the air, enhancing the overall pressure recovery and efficiency of the blower. The constricting ring may also help in evenly distributing the airflow across the rotating blades, reducing the likelihood of uneven loading and associated vibration and noise. The constricting ring may also minimize turbulence and flow separation, which increases aerodynamic efficiency. Further, the constricting ring may function as a venturi, creating a low-pressure area that aids in drawing air into the blower more efficiently.

In another embodiment, the solar panel can be mounted to the roof structure at least ⅓ the way up the run from an overhang to a roof ridge of the roof structure. This can place the solar panel high enough up the roof to acquire adequate exposure to sunlight.

The solar-powered ventilation system of the current embodiments herein can provide improved performance when compared with pre-existing attic ventilation systems. The use of a BLDC motor that is matched with the power characteristics of the solar panel results in a highly efficient system with consistent and strong airflow when solar intensity is high enough to warrant ventilation. The fan blade assembly may include a constricting ring positioned upstream of the rotating blade assembly to optimize airflow dynamics and enhance the efficiency and performance of the blower. The fan blade assembly may include fixed blade assembly downstream from the rotating blade assembly to improve airflow control, enhance efficiency and performance, reduce aerodynamic noise and balance mechanical load distribution.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a solar-powered ventilation system of the current embodiment installed in a building with some portions broken away or in cross section.

FIG. 2 is a perspective view of a fan assembly of the system.

FIG. 3 is a perspective view of the system installed in a soffit opening.

FIG. 4 is a schematic of various components of the attic ventilation system before installation in a building.

FIG. 5 is a schematic representation of the ventilation system installed in a shed.

FIG. 6 is a schematic representation of the ventilation system installed in a recreational vehicle.

FIG. 7 is a perspective view of the fan assembly with the housing in section to show the stationary blade assembly, rotating blade assembly and flow constrictor disposed therein.

FIGS. 8A and 8B are a schematic diagram of the motor control.

### DETAILED DESCRIPTION OF THE CURRENT EMBODIMENTS

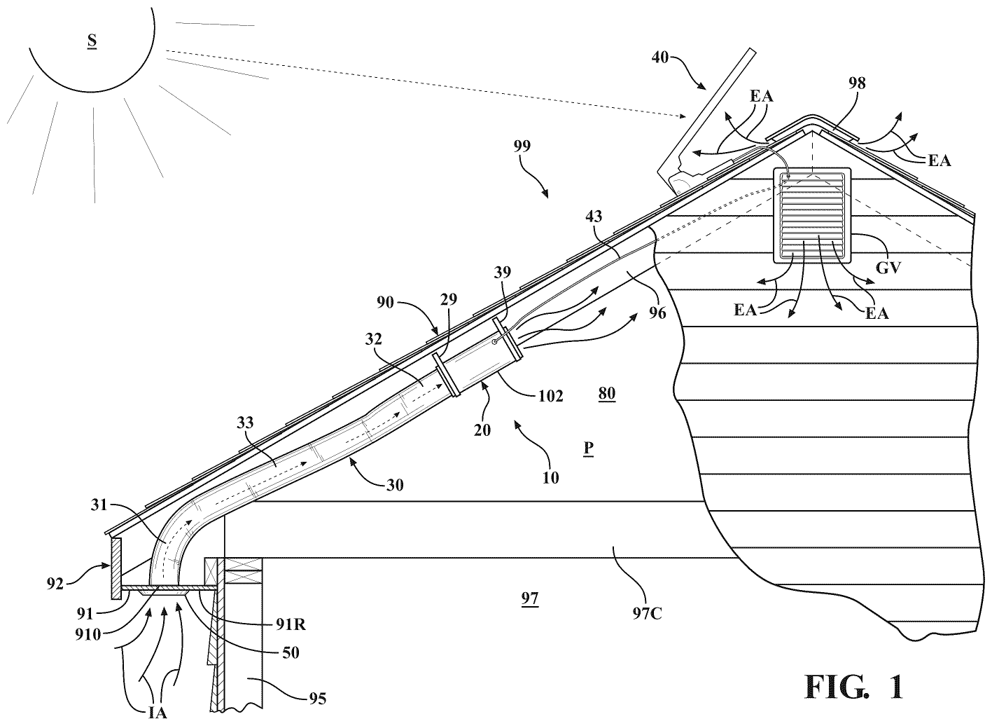

A ventilation system of a current embodiment is shown in FIGS. 1-4 and generally designated 10. FIGS. 1-4 show the ventilation system 10 installed in an attic, though the system 10 can be installed in other enclosed spaces. The ventilation system 10 of the illustrated embodiment generally includes a fan assembly 20, a solar panel 40 and flexible air duct 30. The fan assembly 20 is mounted in an attic space 80 and joined with the flexible air duct 30 that extends to one or more soffits 91 disposed in an overhang 92 of a roof structure 90. In operation, fan assembly 20 is powered by solar panel 40 and draws air through the soffit 91 into the attic space 80. As a result, the fan assembly 20 creates positive pressure within attic space 80, which in turn causes air to vent from the attic space 80. The fan assembly 20 and solar panel 40 are optimized to provide improved ventilation and enhanced performance. The fan assembly 20 includes a brushless DC motor 110 that includes a motor control 112 implementing a commutative control scheme. The solar panel 40 is selected to provide optimized performance in the context of a solar-powered ventilation system. In the illustrated embodiment, the solar panel 40 has a maximum rated power of 40 Watts, though solar panels of different power ratings may be incorporated into alternative embodiments of the present invention. The fan assembly 20 includes an arrangement of airflow components that are selected and optimized for use in a solar-powered ventilation system. In the illustrated embodiment, fan assembly 20 includes a housing 102 that defines an internal flow path. The airflow components are disposed within the internal flow path to provide movement of air through housing 102. The airflow components include a rotating blade assembly 104 that provides airflow and complementary airflow components that optimize the overall aerodynamic performance of the fan assembly 20. The complementary airflow components of the illustrated embodiment include an upstream flow constrictor 106 and a downstream fixed blade assembly 108 that condition airflow into and out of (respectively) the rotating blade assembly to enhance airflow and improve overall efficiency of the system.

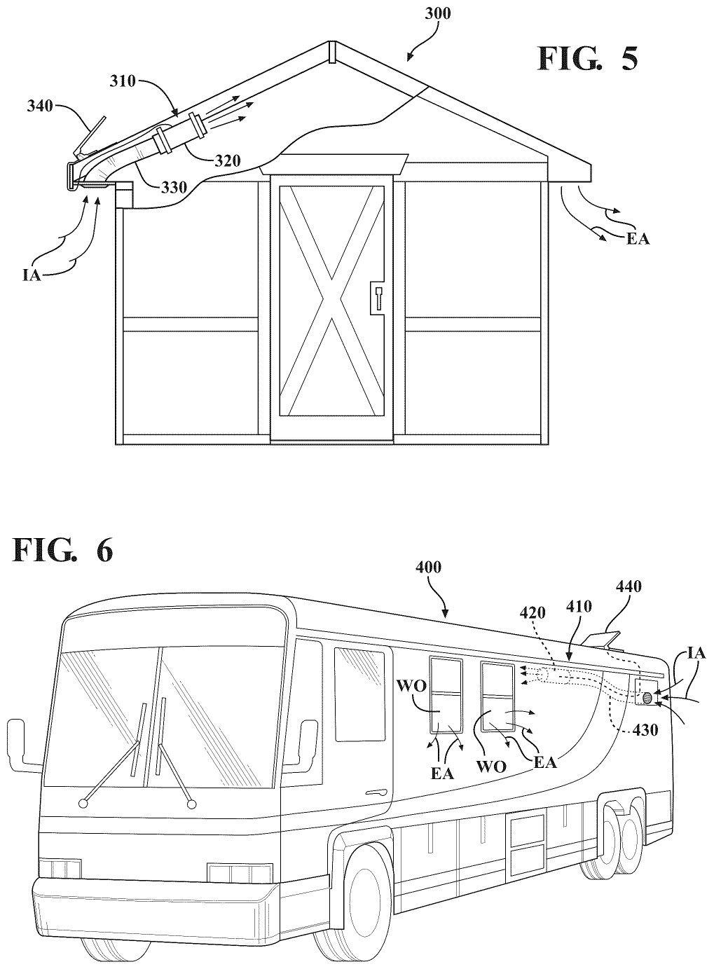

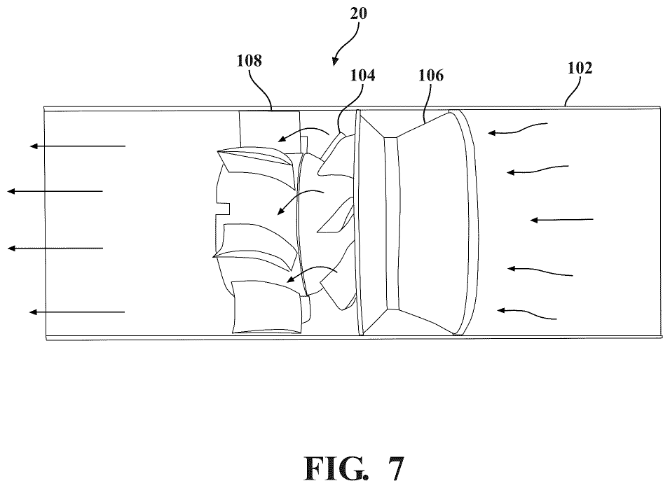

As noted above, ventilation systems in accordance with the present invention are suitable for use in providing ventilation in a wide range of enclosed spaces. For purposes of disclosure and not by way of limitation, the present invention will be described in the context of a building with living space (FIGS. 1-3), a storage shed (FIG. 5) and a recreational vehicle (FIG. 6). U.S. Pub. No. US 2023/0400202 to Greaves entitled “Attic Ventilation System”, which published on Dec. 14, 2023, (a publication of U.S. application Ser. No. 18/141,699, filed on May 1, 2023) is incorporated herein in its entirety.

Referring now to FIGS. 1-3, an embodiment of the present invention incorporated into attic space 80 in building 99 will be described in more detail. In this embodiment, the fan assembly 20 can be completely mounted within the attic space 80 inwardly from the soffit 91, which can define a soffit opening 91O through which ambient intake air IA can be pulled or drawn by the fan assembly 20, through the duct 30 and eventually output into the attic space 80 as ventilating air VA. The fan assembly 20 can increase the pressure P within the attic space 80 so that it is greater than an ambient pressure outside the attic 80, for example outside the building structure 99 and in the environment. This in turn can create a positive pressure P inside the attic 80. The fan assembly 20 can produce the positive pressure to a level such that air exhausts as exhaust air EA through one or more primary vents, one example shown as a ridge vent 98, optionally at the peak or ridge 98R of the roof structure 90 of the building 99. The fan assembly 20 can be powered by a solar panel 40 that is mounted exterior to the attic 80 on the roof structure 90, and optionally facing in a generally southern direction toward the sun S to be satisfactorily suitably operated or charged by solar energy impinging the panel. The solar panel 40 can be electrically coupled via a power cable 43 to the fan assembly 20. Optionally, the solar panel 40 can be mounted to a secondary roof vent (not shown) in some applications. In that case, where the building 99 includes one or more secondary roof vent(s) in addition to ridge vent or other roof vent, the fan assembly creating the positive pressure P inside the attic space 80 can assist in expelling exhaust air EA through the secondary roof vent as well. It will be noted that when the exhaust air EA is expelled from the primary vent 98, the secondary vent or any other roof vent or venting apparatus associated with the roof structure, any heated or higher temperature air within the attic space 80 can be exhausted from the attic space 80, generally out into the environment. In turn, this can facilitate cooling of attic 80, and building 99 in general. This further can reduce the temperature of the living, work and/or storage space 97 located below the attic space 80 within building 99. This can reduce any associated cooling costs for such space 97.

With reference to FIGS. 1-3, the attic ventilation system 10 can be installed in building 99. The building 99 can be a home, garage, storage facility, commercial building, retail outlet or any other type of building. For example, FIG. 5 shows the ventilation system 10 installed in a storage shed 300. The present invention is not, however, limited to use in buildings, but may alternatively be installed in other enclosed spaces where ventilation is desired. For example, FIG. 6 shows the ventilation system 10 installed in a recreational vehicle (“RV”) 400. The building shown in FIG. 1-3 includes a roof structure 90 over an attic 80. The roof structure can include multiple rafters 96. The rafters 96 can be in the form of conventional rafters or can be formed as a part of a truss or other roof structure. The rafters 96 can be spaced from one another about 24 inches or according to local building codes. The roof structure 90, including the rafters 96 can include sheeting and shingles or other roofing components, such as tiles, sheet metal or the like. The roof structure 90 as mentioned above can include a primary vent 98 such as a ridge vent mounted at a peak or ridge 98R of the roof structure 90. This roof vent can provide an opening for exhaust air EA to be expelled from the attic space 80 when adequately pressurized with a positive pressure P relative to the external pressure in the environment surrounding the building. Optionally, as shown, the roof structure 90 also can include a secondary vent, which can be a standard roof vent, which also optionally can provide an output for exhaust air EA to escape the attic 20 when positively pressured by the fan assembly 20.

The building 99 can include the noted attic space 80 and another work, living and/or storage space 97 below a ceiling 97C. The ceiling 97C, or generally the lower portion of attic 80, can include an insulation layer which can provide thermal insulation between attic 80 and the space 97 below it. This insulation layer can be any type of conventional insulation such as batting, spray in foam, foam sheets or the like. Although not shown, additional baffles or venting can be provided between individual ones of the multiple rafters 96 above the attic space 90.

With reference to FIG. 1, building 99 can be configured such that the roof structure 90 extends outwardly a distance from an outer wall 95 that can support a portion of the ceiling 97, the rafters 96 and/or the roof structure 90. Where the roof structure extends outwardly, the distance can optionally be 1 foot, 2 feet, 3 feet or other dimensions depending on the building 99, and it forms the overhang 92. This overhang 92 can be capped by fascia on its outer most portion. The fascia can be disposed the distance from the wall 95. The wall 95 can extend along a vertical plane. The proximal end 31 of the duct 30 can be disposed with its opening adjacent the soffit opening 91O outside the vertical plane of the wall 95. As explained further below, the remainder of the duct 30, the distal or second end 32 of the tube, along with the fan assembly 20, can be disposed on the inside of the vertical plane of the wall, as shown located within the attic space 80 and adjacent one or more of the rafters 96.

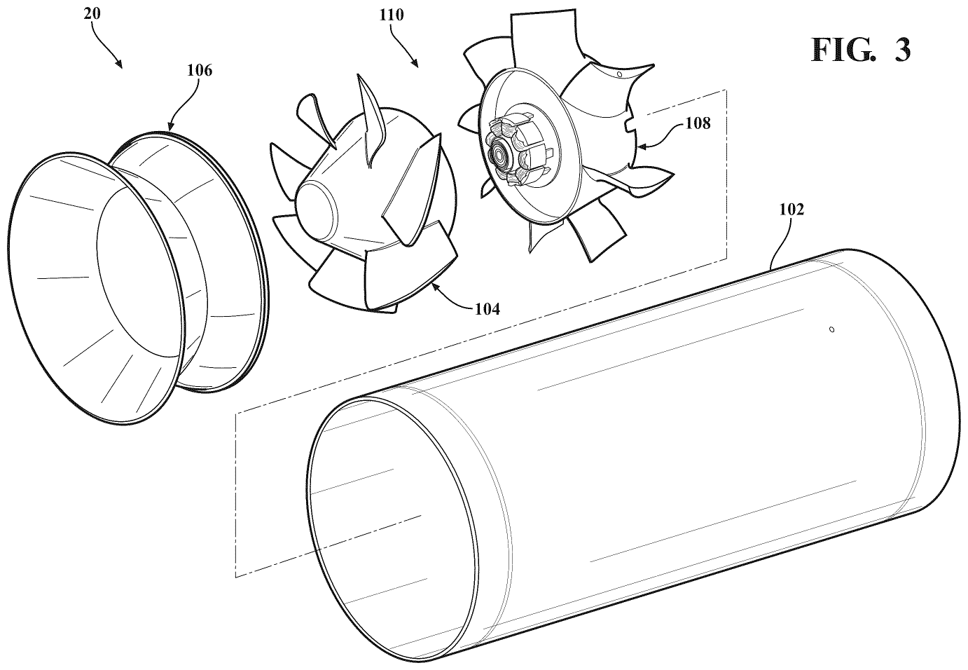

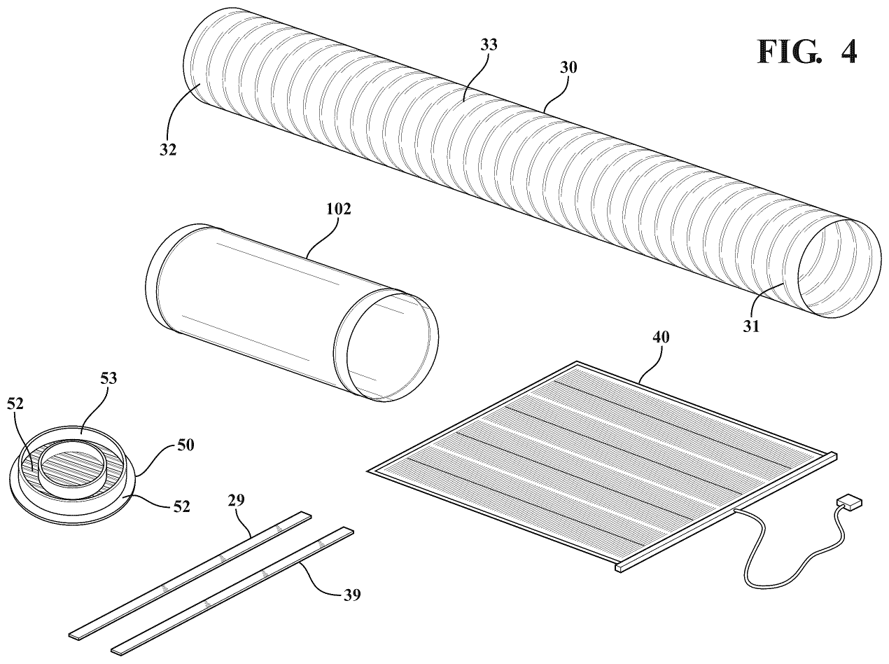

As shown in FIG. 3, the overhang 92 with the fascia and the soffit 91 can extend outwardly from wall 95. The soffit 91 can include a panel 91P defining a soffit opening 91O. Multiple ones of these panels 91P can be joined with one another and can extend along the length of the overhang. The soffit opening 91O can be cut within panel 91P of the soffit 91. The soffit panel 91P also can be modified manually on a job site to include the opening 91O. When this is done, the soffit panel 91P can be cut with a tool, such as tin snips, to form a cut edge 91C that bounds a perimeter of the soffit opening 91O. Typically, this cut edge can be an uneven cut edge which may not be aesthetically appealing. Accordingly, the attic ventilation system 10 can include a trim ring 50 which can include a flange 52 (See FIG. 4) that extends outwardly away from the opening 91 and conceals the uneven cut edge (or any other type of edge) forming the opening in the soffit. The trim ring 50 optionally can include a collar 53 that extends upwardly into the opening 91O, or extends slightly below it, which can be fastened to the soffit panel 91P to secure the trim ring 50 in place. The trim ring 50 optionally can include integrated louvers 55 and/or a screen (not shown). For example, the trim ring 50 may be injection molded with integral louvers 55, and a screen may be added to the trim ring 50 behind the louvers 55 or in place of the louvers 55. The louvers 55 and/or screen can cover the opening 91O within the trim ring 50 such that debris does not easily enter the duct 30. In addition, this can keep animals from entering the opening in the duct. In some applications, however, the trim ring 50 and/or the screen 55 can be absent from the construction.

Returning to FIG. 1, the attic ventilation system 10 as mentioned above can include a duct 30 that extends from the soffit opening 91O to the fan assembly 20. The duct 30 can include a proximal end 31 which is disposed adjacent and in fluid communication with the soffit opening 91O and a distal end 32 which is in fluid communication with and optionally joined with the fan assembly 20. The duct 30 can include a central portion 33 that extends between the proximal end 31 and a distal end 32. This central portion 33 can extend in an upwardly angled disposition relative to the ceiling 97C. The central portion also can transition from outside the vertical plane of wall 95 to inside the vertical plane of wall 95 as it extends generally upwardly. The duct 30 also can extend between one or more rafters, at least in some portions of the central portion and/or the distal end. The proximal end 31 as shown optionally can be disposed on the outside of the wall 95 and below the ceiling 97C in some cases. The central portion 33 and/or the overall length of the duct 30 optionally can be at least 3 feet, at least 4 feet, at least 5 feet, at least 7 feet, at least 8 feet, at least 9 feet, or at least 10 feet long.

In some applications, the overall distance of the fan assembly 20 from the soffit opening 91O can be the same or a similar length as the central portion or overall length of the duct. Optionally, the overall distance PD can be selected so that the fan assembly 20 can adequately draw enough volume of intake air IA without expending significant energy or power to run the fan assembly 20. This can allow the fan motor to be a relatively low voltage, low output fan motor, which can suitably be powered by the solar panel 40 or any secondary batteries (not shown) that may be associated with the fan assembly 20. Further optionally, the overall distance can be less than 12 feet, less than 11 feet, less than 10 feet, less than 9 feet, less than 8 feet, less than 7 feet, less than 6 feet, less than 5 feet, or less than 4 feet depending on the application and the attic space. Again, with the shorter overall distance, the fan assembly 20, which can be low output fan, can suitably pull air from the opening 91O at the proximal end 31 of the duct without requiring too much electricity or power from the solar panel and/or secondary batteries. In the illustrated embodiment, the flexible air duct 30 is configured to mount to the inlet end of the fan assembly housing 102. For example, the flexible air duct 30 has an interior diameter that corresponds with the external diameter of the housing 102 so that the duct 30 can be fitted about the housing 102 at the inlet end. In this embodiment, the flexible air duct 30 can be secured in place about the housing 102 by a duct clamp (also known as “duct band clamps” or “hose clamps”) (not shown).

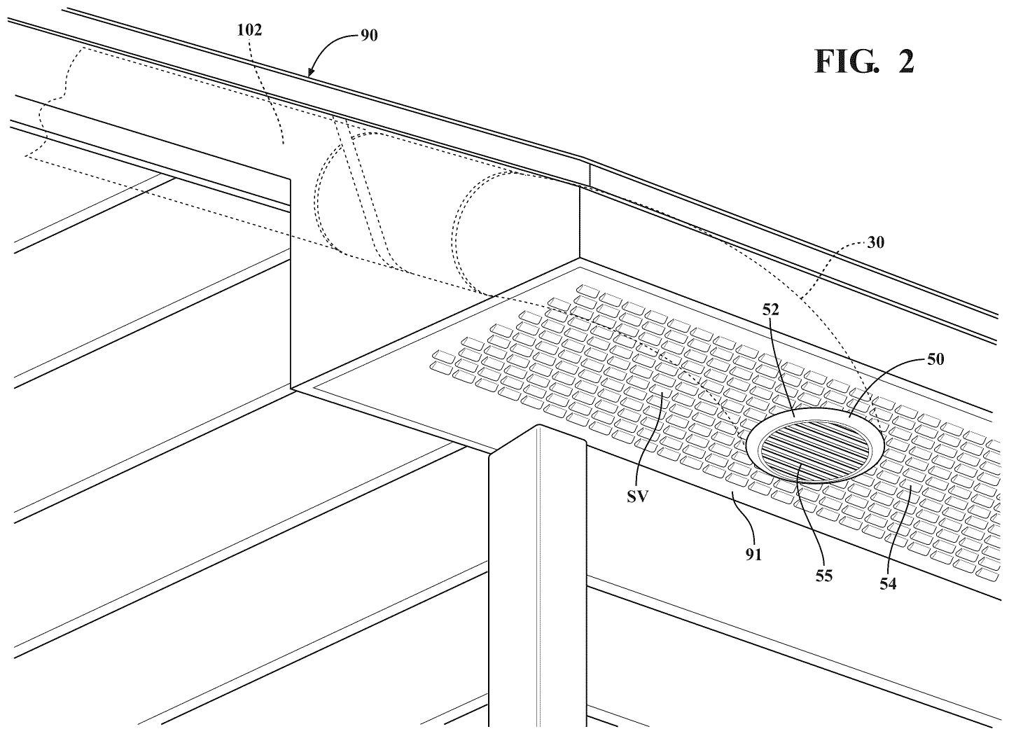

Although the illustrated embodiments of the present invention incorporate a duct 30 that forms an inlet flow path to the fan assembly 20, the ventilation system 10 may alternatively be arranged so that the duct 30 provides an outlet flow path from the fan housing to the exterior. In alternatively arrangements of this type, the fan assembly 20 can be used to create a negative pressure within the enclosed space, thereby drawing fresh air into the enclosed space through exiting vents or other openings between the enclosed space and the surrounding environment. For example, in the context of the attic space shown in FIGS. 1-2, the duct may be mounted between the outlet end of the fan housing 102 and the gable vent GV. In this alternative arrangement, the inlet of the fan housing is open to the interior of the enclosed space and, during operation, the fan assembly 20 expels air from the interior of the enclosed space into the environment through the gable vent GV, which draws fresh air into the enclosed space through the soffit vents SV. To facilitate these alternative configurations, ventilation system 10 may be configured so that the flexible air duct 30 can be easily mounted to either the inlet or outlet end of the housing 102. As shown, housing 102 is hollow cylindrical sleeve in which opposite ends have the same outer diameter and are equally capable of receiving an end of the duct 30.

The fan assembly 20, as well as solar panel 40 also can be located on the roof structure 90 generally between the roof overhang 92 in the roof ridge 98R. The placement of these elements can be sufficiently distal from the overhang 92 in the soffit 91 so that the fan assembly 20 is adequately disposed in the attic 80 to move ventilating air VA into that space and produce a positive pressure P within the space. The solar panel 40 also can be located along the roof structure such that the panel is distal from the overhang and sufficiently high on the roof to collect enough solar energy from the sun S. Optionally, both the fan assembly 20 and solar panel 40 can be disposed on the inside of the vertical plane of the wall 95 opposite the overhang 92 and/or soffits 91. Although the illustrated embodiment shows fan assembly 20 oriented to move airflow in a direction parallel to the trusses in the roof structure, the fan assembly 20 can be positioned in other orientations to direct airflow in other directions. For example, in alternative applications, fan assembly 20 may be positioned below the trusses and oriented in a direction perpendicular to the length of the trusses. This may, in some applications, enhance overall airflow within the attic space. Similarly, the illustrated embodiment shows fan assembly 20 situated roughly midway between the soffit and the peak of the roof. It should be understood that the position of the fan assembly 20 may vary from application to application. For example, in some applications, fan assembly 20 may be situated toward the bottom of the roof 90 just above the soffit 91. This can result in a longer airflow path between the fan assembly 20 and the exit vents, thereby potentially enhancing overall airflow through the attic space. In some applications, the fan assembly 20 may be positioned as remote from the vents as reasonably possible. The fan assembly 20 and/or solar panel 40 can be positioned at certain locations along the run distance of the roof structure 90 that extends from the overhang 92 to the roof ridge 98R. For example, solar panel 40 can be located at least ¼, at least ⅓, at least ½, at least ¾ or at least ⅔ the run distance from the overhang. The fan assembly 20 can be located at least ¼, at least ⅓, at least ½, at least ¼, at least ⅓, at least ½, at least ¾, at least ⅔ the run distance from the overhang. In other applications, the fan assembly 20 can be located from ¼ to ⅓ the run distance, ⅓ to ⅔ the run distance, ½ to ¾ the run distance, or ⅓ to ⅔ the run distance, from the overhang, depending on the application.

The duct 30, extending from the proximal end 31 to the distal end 32, can be a rigid or flexible duct. In some cases, the duct can be flexible, which can include semi rigid or semi flexible ducts. In this construction, the duct can be easily manipulated, rerouted and directed from the soffit opening 91O, over the top of the wall 95, and adjacent and/or between certain ones of the rafters 96. In some cases, although shown between rafters, the duct 30 and optionally the fan assembly 20 can be secured directly under one rafter. In other applications, the duct and fan can be supported by a stand or bracket that extends upward from the ceiling 97C in the attic space. In either case, the fan assembly 20 and duct can be considered to be suspended.

With further reference to FIG. 2, fan assembly 20 can be located at the distal end 32 of the duct. Fan assembly 20 can be attached to the duct via a clamp, zip tie, fasteners or other types of connecting elements. The fan assembly 20 as well as the duct 30 optionally can be fastened or otherwise secured to the rafters 96 or some portion of the roof structure 90 and/or the ceiling 97C via one or more bands 29 and 39. The bands as shown can be elongated elements optionally including one or more holes defined therein. Fasteners 29F can be placed through one or more holes defined by bands 29 to fasten the ends or other portions of the bands to the rafters, roof structure, ceiling or otherwise in the attic space. The bands as used herein can take on a variety of shapes, configurations and constructions, optionally constructed from metal, plastic, composites or the like. The bands 29 and 39 can be in the form of rigid or flexible elongated elements that can be secured to the rafters, roof structure, ceiling, or other components inside the attic space. In some cases, the bands can be in the form of strips, cords, wire, rope, or other elongated pieces. In other cases, the bands can be in the form of rigid or semi rigid brackets that can be secured to the rafters, the ceiling or elsewhere in the attic space. These bands can be part of the fan assembly 20 or can be separate pieces from the fan. Further, although shown as suspending the fan assembly 20 and/or duct 30 from the rafters or roof structure, the bands can support the elements by extending upward from the ceiling 97C or some other structure of the building 99. Furthermore, where the fan or duct are referred to as suspended, this can refer to supporting the fan and/or duct from below those elements, as well as from above those elements.

When mounted to the rafters 96 or some other structure within the attic space 80, the fan assembly 20 can be disposed below the roof structure 90 and above the ceiling 97C, as well as any optional insulation. As shown in FIG. 1, fan assembly 20 can be mounted so that the exhaust end 22 of the fan is disposed a clearance distant above where insulation may lay in the rafters 96. This is so that the fan does not inadvertently blow or disrupt the insulation and circulate fibers or other material from the insulation within attic 80. The distance above the insulation can optionally be at least 2 feet, at least 3 feet, at least 4 feet, at least 5 feet or at least 10 feet above the insulation layer, depending on the application.

With further reference to FIG. 2, fan assembly 20 may optionally include a direct current motor. Fan assembly 20 includes a rotating blade assembly 104 that includes a plurality of blades arranged symmetrically about the rotor. As shown, the rotating blade assembly 104 is shrouded within the fan housing 102. The fan can include a brushless motor 110 that can be operable at optionally less than 30V, 28V, 20V, less than 12V, or less than six volts DC depending on the application. The fan assembly can be operable such that it can output air from the exhaust side 22 at an airflow rate of at least 300 CFM, at least 325 CFM, at least 350 CFM, at least 375 CFM, at least 400 CFM.

Although shown as a single fan installed in attic 80, there can be multiple fans and associated ducts mounted in attic 80. These multiple fans and ducts can extend from corresponding respective soffits 91 and respective openings 91O along the overhang 92 of the roof structure 90. The number of fans can be selected depending on the suitable airflow, cooling and temperature in the attic 80, as well as other parameters. For example, in one alternative embodiment, four ventilation systems can be installed in the four corners of the attic space (not shown). In this type of alternative embodiment, the four ventilation systems may be arranged so that the fan assemblies draw in fresh air through the soffits in the four corner of the attic space and blow the fresh air inwardly toward the center of the attic space in a direction perpendicular to the length of the trusses, thereby causing fresh air to flow through much of the attic space.

Although not shown, fan assembly 20 optionally can include a thermostat and/or humidistat (not shown) on the housing of the fan. This can control the operation of the fan assembly according to a preset temperature or humidity. The preset temperature and/or humidity can be set manually by user using a control knob or other input on the thermostat and/or humidistat. The fan assembly 20 can start, run and stop depending on control signals provided by the thermostat and/or humidistat 23. Further optionally, the fan assembly 20 can additionally or alternatively be remotely controlled by a secondary thermostat and/or humidistat (not shown). This secondary thermoset and/or humidistat can be placed in the living, work and/or storage space 97 below the ceiling 97C. This secondary thermostat and/or humidistat also can include an input, such as a control knob, button or the like so that a user within space 97 can set a temperature or humidity within the attic 80 at which the fan will be triggered to operate. The secondary thermostat and/or humidistat can send wireless signals to the fan or a controller thereof to control the fan operation. In other cases, the secondary thermostat and/or humidistat can be hardwired to the fan to control its operation.

The attic ventilation system 10 can operate to produce a positive pressure P in the attic 80 using the fan assembly 20 pulling intake air IA from the environment through the soffits 91 associated with the roof structure 90. The fan specifically can produce a negative pressure within duct 30 which then draws an intake air IA through the opening 91O into the proximal end 31 of the duct. The air can continue to flow through the central portion 33 and distal end of the duct 32 until being blown by the fan assembly 20 into the attic 80 as ventilation air VA. The ventilation air can pressurize the attic 80 with the pressure P. Where positive, the pressure can result in air being expelled through any respective vents 98 and GV as exhaust air EA from the attic space 80 and generally from the building 90. Optionally, the fan can pull cool ambient intake air from the region under the overhang 92 and expel that as ventilation air VA into the attic space 80, which can be of a higher temperature air. As result, the overall air temperature in the attic 80 can decrease. This can result in a corresponding lower temperature in the living, work or storage space 97 within building 99. Although shown as pulling in air through the intake, the fan also can be reversed to draw air out of the attic 80 and blow it through the soffit opening 91O into the environment, in some limited applications.

In some cases, ventilation system 10 can be supplied in a kit form as shown in FIG. 4. There, the kit can include a flexible air duct 30, one or more mounting bands 29, 39, the fan assembly 20, the solar panel 40, the power cord 43 as well as the trim ring 50 and an optional secondary thermostat and/or humidistat (not shown). Of course, other fasteners, connectors, controllers, cords and the like can be included in the kit depending on the application.

As discussed above, the ventilation system 10 is optimized to provide efficient and effective operation. As discussed above, fan assembly 20 is powered by a solar panel 40. The solar panel 40 is mountable to an external structure proximate the enclosed space, such as a roof or wall, in a position where the solar panel is exposed to sunlight (typically, direct sun light). The illustrated solar panel 40 is mounted somewhere on the roof structure 90, optionally above the fan assembly 20 and duct 30. The solar panel 40 can be mounted via a support bracket that is adjustable to orient the solar panel 40 at different angles relative to the roof structure 90. The solar panel 40 can be oriented on the roof to maximize the amount of solar energy from the sun S impinging on the panel throughout the day and year. In this embodiment, solar panel 40 is selected to provide sufficient power to operate the fan assembly 20 to provide adequate ventilation under conditions when ventilation is most desirable. For example, solar panel 40 may be selected with a rated maximum power of 40 Watts. In other applications, the rated maximum power output of the solar panel may be different, such as 30 Watts, 35 Watts, 45 Watts or 50 Watts. In the illustrated embodiment, the output of the solar panel 40 is communicated to the fan assembly 20 by power cord 43. The power cord 43 may be routed from the solar panel 40 into the enclosed space through a vent or other opening.

The ventilation system 10 can include optional secondary batteries (not shown). These batteries can be charged by the solar panel 40 when the solar panel absorbs solar energy. The batteries thus can be used to power the fan assembly 20 when the solar panel 40 is not absorbing sufficient solar energy, such as during the night and/or during low sunlight days.

To provide an efficient motor, the fan assembly 20 of the illustrated embodiment includes a brushless DC (“BLDC”) motor 110 with a stator that is fixed within the housing 102 and a rotor that is configured to rotate within the housing 102. Although the configuration of the motor may vary from application to application, the motor of the illustrated embodiment is a three-phase DC motor having a plurality of permanent magnets in the rotor and a plurality of stationary windings in the stator. In operation, the motor control (discussed in more detail below) energizes (or commutates) the windings in the stator in a controlled sequence to produce a rotating magnetic field that interacts with the permanent magnets in the rotor to drive rotation of the rotor. The winding configuration may vary from application to application, but in the illustrated embodiment the windings are arranged about the stator to provide the BLDC motor 110 with nine poles (three poles for each phase). In alternative embodiments, the motor may be one- or two-phase motor and the winding may be configured with a different number of poles. The illustrated motor 110 has a starting voltage of about 6 VDC and an operating voltage range of about 8 VDC to about 28 VDC. The starting voltage and operating voltage range may vary from application to application depending, in part, on the power requirements of the BLDC motor. Optionally, the motor 110 may be a soft-start motor in which the voltage applied to the windings is controlled.

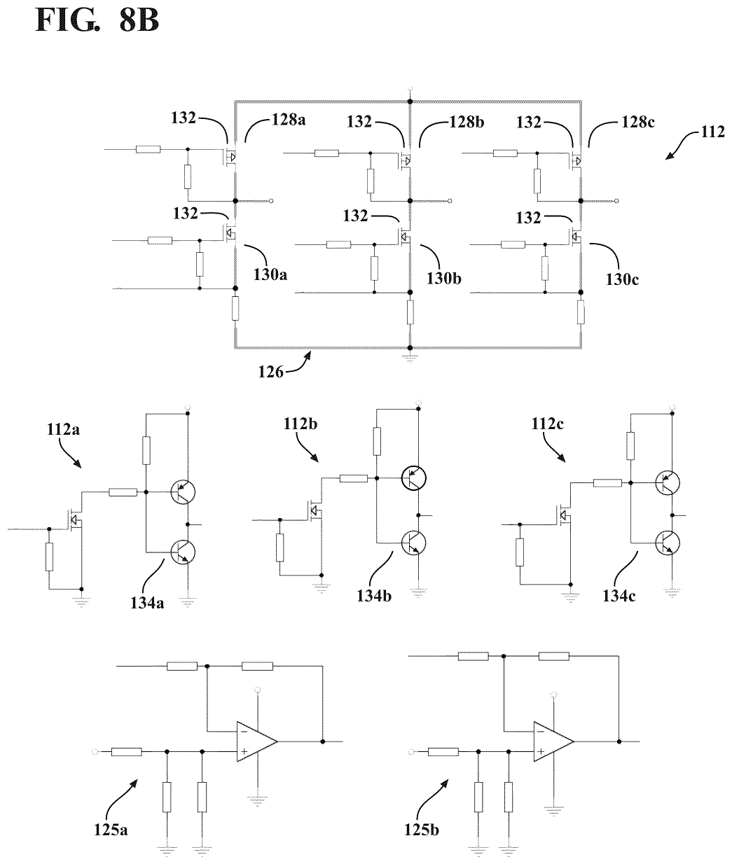

Operation of the BLDC motor 110 is provided by an electronic motor control 112. In the illustrated embodiment, motor control 112 is configured to engage the motor 110 only when the solar panel 40 provides power sufficient to properly operate the motor 110. It has been determined that this is generally acceptable as ventilation is typically unnecessary when the solar intensity is not sufficient for the solar panel 40 to provide adequate power. For example, in the illustrated embodiment, motor control 112 does not attempt to operate motor 110 unless the power received from the solar panel 40 is sufficient to provides at least about 6 VDC to the motor 110. The starting threshold may vary from application to application depending primarily on motor specifications. The illustrated motor control 112 includes a microcontroller 120 programmed to implement commutative control algorithms that provide efficient operation of the motor 110 utilizing power available from the solar panel 40. The motor control 112 may implement generally conventional commutative control algorithms in which the motor control 112 is continuously monitoring operation of the motor 110, for example, monitoring the current and/or voltage applied to the windings, as well as the current and/or voltage flowing through the windings, and adjusting the application of power to the three-phases of the motor 110 to provide generally constant speed for the available level of power (as supplied by the solar panel 40). As shown in FIG. 8A, motor control 112 may also include a voltage regulation subcircuit 121 that receives input power from the solar panel 40 and provides a 5 VDC output for use by circuit components that operate from 5 VDC. The motor control 112 may further include a voltage sense subcircuit 123 that provides the microcontroller 120 with a signal proportional to the input voltage.

Referring again to FIGS. 8A-B, microcontroller 120 is programmed to provide control signals that control the supply of power to the three different phases of motor 110. The microcontroller 120 is a generally conventional microcontroller having a variety of analog and digital inputs and outputs and is programmed to implement the desired control algorithm. In this embodiment, the BLDC motor 110 is a three-phase motor and the motor control 112 includes power transistors that are used to form a three-phase inverter 126 with three pairs of switches (each pair including a high-side switch 128a-c and a low-side switch 130a-c). As shown in FIG. 8B, motor control 112 includes six power transistors 132 arranged in a three-phase bridge configuration, with each pair governing the switching for one phase of motor 110. The power transistors 132 may be MOSFETs, though other types of power transistors may be used in alternative applications.

In the illustrated embodiment, motor control 112 is programmed to output control signals that drive the three phases of motor 110. The control signals include high-side control signals and low-side control signals that operate the high-side switches and the low-side switches, respectively. In the illustrated embodiment, motor control 112 has an arrangement of gate drivers 122a-c that operate the high-side power transistors 132 to supply power to the high-side for the different phases of the motor 110. As shown in FIG. 8B, each gate driver 122a-c may include a pair of transistors 134a-c that assist in shifting the voltage level of the control signals to the gate drive levels. In operation, the gate drivers 122a-c amplify the high-side control signals coming from the microcontroller 120 and apply the amplified signals to drive the power transistors 132 in an appropriate sequence. More specifically, the gate drivers 122a-c amplify the high-side control signals to the level required to actuate the power transistors 132 of the high-side switches 128a-c. In the illustrated embodiment, the microcontroller 120 applies the low-side control signals directly to the low-side switches 130a-c, though a wide variety of alternative configurations can be implemented in alternative embodiments.

In the illustrated embodiment, the BLDC motor 110 is controlled using a voltage control algorithm, which involves regulating the voltage supplied to the motor windings to control its speed and/or torque. For example, the illustrated motor control 112 uses pulse-width modulation (“PWM”) to control the voltage and current supplied to the motor windings. More specifically, the illustrated microcontroller 120 is configured to output PMW signals generated under precise control to actuate the three switch pairs. In this embodiment, the motor control 112 supplies separate PMW signals for each phase to the corresponding high-side gate drivers 122a-c so that each high-side gate driver 122a-c actuates a separate one of the high-side power transistors 132 and therefore controls the high-side of a separate phase.

In the illustrated embodiment, the motor control 112 implements a sensorless commutation control scheme in which internal feedback, such as current, voltage or electromotive force (“back-EMF”) is used to determine the precise sequence for switching the current in the stator windings across the three phases to generate a rotating magnetic field. For example, FIG. 8B shows current sense subcircuits 125a-b that provide the microcontroller 120 with signals that are proportional to current in the first two phases of motor 110. In this embodiment, the current sense subcircuits 125a-b each include an op amp 127 arranged to amplify the current sense output signal to an appropriate level for use by the microcontroller 120. In alternative embodiments, the motor control 112 may implement a sensor-based commutation scheme in which the control signals are based, at least in part, on sensor feedback, such as hall effect sensors that are arranged to operatively interact with permanent magnets in the rotor.

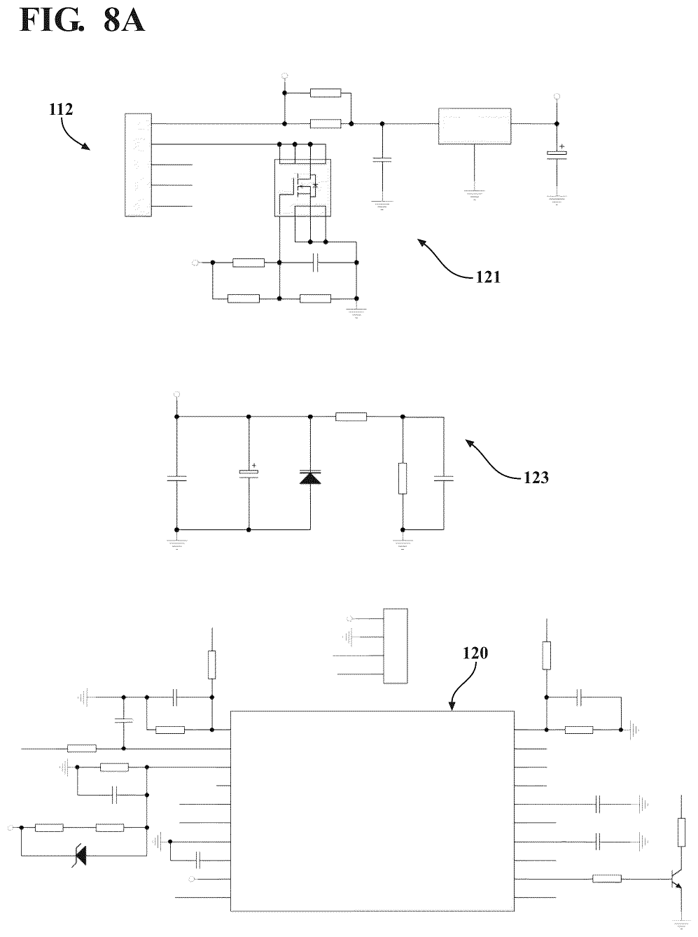

In the illustrated embodiment, the fan assembly 20 includes a rotating blade assembly 104 affixed to the rotor of the BLDC motor 110 such that operation of the motor 110 results in rotational of the rotor and consequently the rotating blade assembly 104, which in turn causes the flow of air through the housing 102 (See FIGS. 3 and 7). The illustrated fan assembly 20 also includes a stationary blade assembly 108 that is affixed to the housing 102. For example, in the illustrated embodiment, a plurality of fasteners extend through the housing 102 into the ends of certain blades in the stationary blade assembly 108 to hold the stationary blade assembly 108 in place. As shown, stationary blade assembly 108 is disposed downstream from the rotating blade assembly 104. In this embodiment, the motor 110 and motor control 112 are mounted to the stationary blade assembly 108. For example, the stationary blade assembly 108 may include a central motor mount 140 to which the stator of the motor 110 and the motor control 112 are affixed. The blades of the stationary blade assembly 108 may extend in a radially symmetric pattern about the circumference of the central motor mount 140. In this embodiment, the stationary blade assembly 108 is configured to direct and straighten the swirling airflow that exits the rotating blade assembly 104. For example, the fixed blades may be configured to convert rotational energy into linear airflow, thereby reducing turbulence and increasing efficiency which result in more consistent and directed airflow.

The fan assembly 20 of the illustrated embodiment also includes a flow constrictor disposed upstream from the rotating blade assembly 104. The illustrated flow constrictor is a constricting ring 106 that is fixed to the housing 102 adjacent to the rotating blade assembly 104 such that airflow moves through the constricting ring 106 just prior to engaging with the rotating blade assembly 104. The illustrated constricting ring 106 is generally ring-shaped and has a somewhat triangular cross section that gradually constricts and then gradually opens the airflow path. As shown in FIG. 3, the rotating blade assembly 104 may include a truncated nose cone 142 that extends into the interior of the constricting ring 106. The constricting ring 106 may provide a range of benefits. For example, the constricting ring 106 is selected to convert static pressure into dynamic pressure as the air accelerates through the narrow section, which improves energy transfer from the blades to the air, enhancing the overall pressure recovery and efficiency of the fan assembly. The constricting ring 106 may also help in evenly distributing the airflow across the rotating blades, reducing the likelihood of uneven loading and associated vibration and noise. The constricting ring 106 may also minimize turbulence and flow separation, which increases aerodynamic efficiency. Further, the constricting ring 106 may function as a venturi, creating a low-pressure area that aids in drawing air into the blower more efficiently.

The rotating blade assembly 104, fixed blade assembly 108 and flow constrictor 106 may be manufactured using conventional techniques and apparatus. For example, the rotating blade assembly 104 may be injection molded from suitable polymeric materials (such as ABS, polycarbonate or nylon). The material may include additives (such as glass fibers, carbon fiber, mineral fillers, UV stabilizers, thermal stabilizers, impact modifiers and colorants) that improve strength or other characteristics.

As discussed above, the present invention is well-suited for use in a wide range of enclosed spaces where ventilation is desired. FIG. 5 is an illustration showing an embodiment of the present invention installed in a storage shed 300. The storage shed 300 does not have an enclosed attic, but the interior of the storage shed 300 is an enclosed space. In this embodiment, the ventilation system 310 provides ventilation for the interior of the storage shed 300. As shown, the solar panel 340 is mounted atop the roof R, the fan assembly 20 is mounted beneath the roof R and the flexible air duct 330 is installed in the soffit S to provide an inlet from the environment to the fan assembly 320. In alternative embodiments, the flexible duct 330 may be mounted in other locations, such as in a wall of the shed 300, in a gable vent or in a window opening. It should also be noted that, in alternative embodiments, the flexible air duct 330 may be used to provide an exit air flow passage for the ventilation system 310. For example, the fan assembly 320 may be mounted near the peak of the roof and the flexible air duct 330 may be mounted within a roof vent, a gable vent (not shown) or another opening. In this configuration, the fan assembly 320 creates a negative pressure within the interior of the storage shed 300, which draws fresh air into the enclosed space from the environment, for example, through the soffit vents, windows, or other openings. The fan assembly 320 may be installed remotely from the air inlet(s) to increase the path through which fresh air travels through the enclosed space to reach the fan assembly 320.

FIG. 6 shows an alternative embodiment of the present invention installed in a recreational vehicle (“RV”) 400. In this embodiment, the ventilation system 410 is configured to ventilate the interior of the RV 400. The solar panel 40 may be mounted to the side of the top or side of the RV 400, the fan assembly 20 is situated within the RV 400 and the flexible air duct is installed in a window opening WO to provide an inlet from the environment to the fan assembly 420. The windows of the vehicle or other integrated vent (such as a bathroom vent) may provide an outlet path for air to vent from the interior of the RV 400. When venting through windows, one or more of the windows in the vehicle may be opened a relatively small amount to create a ventilation opening. To enhance ventilation, a window (or windows) remote from the fan assembly 420 may be opened. In this embodiment, the solar panel 440 may be affixed atop the roof or to the side of the RV 400 using essentially any desired mounting structure. For example, solar panel 440 may be attached using a plurality of suction cups that adhere directly to the RV 400. This provides a temporary mounting structure that allows the solar panel 440 to be readily removed when not needed. However, in alternative embodiments, the solar panel 440 can be mounted to the RV 400 using a more permanent arrangement, such as through the use of fasteners or by attachment to a roof rack or other roof structure. In alternative embodiments, the flexible duct 430 may be mounted in other locations, such as in other window openings or in a pre-existing vent (e.g. a bathroom or HVAC vent) or a newly created vent formed for use with the ventilation system 410. It should also be noted that, in alternative embodiments, the flexible air duct 430 may be used to provide an exit air flow passage for the ventilation system 410. For example, the fan assembly 420 shown in FIG. 6 may be reversed so that it exhausts air through the flexible air duct 430 to create negative pressure within the interior of the RV 400, which draws fresh air into the RV 400 from the environment, for example, through windows, existing ventilation openings or other openings.

It will be appreciated that by identifying or naming herein certain elements as first, second, third, etc., that does not require that there always be a certain number of elements preceding, succeeding, above, below, adjacent and/or near the numbered elements. Further, any one of a numbered group of elements, for example, a third element, alternatively can be referred to as a first, second, fourth or other numbered row element. The same is true for the naming of any other elements in the form of a first element, second element, third element, etc. as used herein.

Although the different elements and assemblies of the embodiments are described herein as having certain functional characteristics, each element and/or its relation to other elements can be depicted or oriented in a variety of different aesthetic configurations, which support the ornamental and aesthetic aspects of the same. Simply because an apparatus, element or assembly of one or more of the elements is described herein as having a function does not mean its orientation, layout or configuration is not purely aesthetic and ornamental in nature.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

What is claimed is:

1. A ventilation system for moving air through an enclosed space comprising:
a solar panel configured to be mounted outside an enclosed space, the solar panel having a maximum power output of at least about 30 Watts;
a fan assembly disposed within an enclosed space, the fan assembly including a brushless direct current (“BLDC”) motor and a motor control providing commutative control to the BLDC motor, the BLDC motor electrically coupled to the solar panel, wherein the fan assembly has a maximum airflow rate of at least about 350 cubic feet per minute (“CFM”);
an air duct with a first end coupled to the fan assembly and a second end coupled to at least one of an inlet or an outlet in an enclosed space; and
a trim ring configured to surround to be mounted to at least one end of the air duct.

2. The ventilation system of claim 1, wherein the BLDC motor is a three-phase motor and the motor control is configured to implement three-phase commutative control.

3. The ventilation system of claim 1, wherein the BLDC motor is a nine-pole three-phase motor.

4. The ventilation system of claim 3 wherein the solar panel has a maximum power output of at least about 40 Watts.

5. The ventilation system of claim 1, wherein the fan assembly includes:
a tubular housing with a hollow interior;
a rotating blade assembly disposed in the hollow interior, the rotating blade assembly operatively coupled to the BLDC motor, whereby rotational operation of the BLDC motor rotates the rotating blade assembly, thereby creating airflow through the housing of the fan assembly in an upstream to a downstream direction; and
a fixed blade assembly disposed within the housing downstream from the rotating blade assembly.

6. The ventilation system of claim 5, wherein the fan assembly further includes a constricting ring disposed within the housing upstream from the rotating blade assembly, the constricting ring gradually narrowing an airflow path upstream from the rotating blade assembly.

7. The ventilation system of claim 6, where in the housing includes inlet and outlet ends, the inlet and outlet ends being circular with each having an outer diameter substantially corresponding with an inner diameter of the air duct, whereby the air duct is selectively mountable to either the inlet end or the outlet end of the air duct.

8. The ventilation system of claim 6, wherein the fan assembly has a maximum airflow rate of at least about 400 CFM.

9. A ventilation system kit for retrofitting into an enclosed space comprising:
a solar panel and associated mounting bracket, the solar panel having a maximum power output of at least 30 Watts;
a fan assembly including a tubular housing defining an internal airflow passage having an inlet and an outlet, a motor disposed within the housing in the internal airflow passage, a rotating blade assembly operatively coupled to the motor for rotational movement within the housing, whereby operation of the motor rotates the rotating blade assembly causing airflow through the housing in a direction from the inlet to the outlet;
a power cord configured to electrically coupled between the solar panel to the fan assembly;
an air duct having a first end and a second end, the first end being operatively coupled to the inlet to provide an airflow passage from an environment to the housing or to the outlet to provide an airflow passage from the housing to an environment; and
a trim ring mounted to a first end or a second end of the air duct, the trim ring having a concealing flange; and
wherein the fan assembly includes a motor control configured to provide commutative control of the BLDC motor, wherein the fan assembly provides a maximum airflow rate of at least about 350 CFM while operating under power provided by the solar panel.

10. The ventilation system kit of claim 9 wherein the fan assembly includes a constricting ring disposed in the housing between the rotating blade assembly and the inlet.

11. The ventilation system kit of claim 9 wherein the fan assembly includes a fixed blade disposed in the housing between the rotating blade assembly and the outlet.

12. The ventilation system kit of claim 9 wherein the fan assembly includes a constricting ring disposed in the housing between the rotating blade assembly and the inlet and a fixed blade disposed in the housing between the rotating blade assembly and the outlet.

13. The ventilation system kit of claim 12 wherein the BLDC motor is a three-phase motor.

14. The ventilation system kit of claim 12 wherein the BLDC motor is a nine-pole, three-phase motor.

15. The ventilation system kit of claim 14 wherein the BLDC motor is a soft-start motor having a starting voltage of at least about 6V and an operating voltage range with a voltage minimum of at least 8V.

16. The ventilation system kit of claim 15 wherein the motor control includes a plurality of switch pairs arranged in a three-phase bridge with one switch pair for each motor phase, each switch pair including a high-side switch and a low-side switch.

17. The ventilation system kit of claim 16 wherein the motor control includes a plurality of high-side gate drivers that operate the high-side switches of each switch pair.

18. The ventilation system kit of claim 17 wherein the motor control includes a plurality of high-side gate drivers, each of the high-side gate drivers operate a corresponding one of the high-side switches of each switch pair.

19. The ventilation system kit of claim 18 wherein the solar panel has a maximum power output of at least 40 W and the fan assembly has a maximum airflow rate of at least about 400 CFM.

20. A ventilation kit configured to be installed in an enclosed space comprising:
a solar panel;
a fan assembly;
a power cord electrically coupling the solar panel to the fan assembly; and
a flexible air duct;
wherein the solar panel is provided with a mounting bracket configured to mount the solar panel to a structure external to the enclosed space, the solar panel having a maximum rated power output of at least about 40 Watts;
wherein the fan assembly is configured to be mounted inside the enclosed space and includes a housing, a motor and a motor controller, the housing having an inlet end and an outlet end, the motor being disposed in the housing and being a brushless direct current motor, the motor controller receiving power from the solar panel via the power cord, the motor controller providing commutative control of the motor;
wherein the fan assembly includes a rotating blade assembly, a fixed blade assembly and flow constrictor, the rotating blade assembly being operatively coupled to the motor for rotational movement within the housing, whereby operation of the motor rotates the rotating blade assembly causing airflow through the housing in a direction from the inlet to the outlet, the fixed blade assembly being disposed in the housing adjacent the rotating blade assembly, the fixed blade assembly receiving airflow generated by the rotating blade assembly, the flow constrictor being disposed in the housing adjacent the rotating blade assembly opposite the fixed blade assembly, the flow constrictor shaping the airflow entering the rotating blade assembly;
wherein the air duct is coupled to the inlet end or the outlet end of the housing;
wherein the fan assembly provides a maximum airflow rate of at least about 350 CFM when receiving maximum power from the solar panel.
